(19) United States
(12) Patent Application Publication
(10) Pub. No.: US 2011/0109523 A1
(43) Pub. Date: May 12, 2011

(54) RADOME SANDWICH PANEL STRUCTURAL JOINT

(75) Inventors: David Stresing, Kent, OH (US); Kevin Todd, New Waterford, OH (US)

(73) Assignee: SAINT-GOBAIN PERFORMANCE PLASTICS CORPORATION, Aurora, OH (US)

(21) Appl. No.: 12/943,459

(22) Filed: Nov. 10, 2010

Related U.S. Application Data
(60) Provisional application No. 61/259,852, filed on Nov. 10, 2009.

(51) Int. Cl. H01Q 1/42; B23P 11/00

(52) U.S. Cl. 343/872; 29/525.01

(57) ABSTRACT

A radome includes first and second panels disposed adjacent to each other and a fastener. Each panel of the first and second panels includes a core material disposed between first and second skin layers. The core of the first panel abuts the core of the second panel at respective edges. A first skin layer of the first panel extends past the edge of the first panel and overlaps a thinned portion of the second panel defined contiguous with the edge of the second panel. A first opening defined through the first skin layer of the first panel is in alignment with a second opening defined through the thinned portion of the second panel. The fastener extends through the first and second openings to secure the first panel to the second panel.

### CROSS-REFERENCE TO RELATED APPLICATION(S)

The present application claims priority from U.S. Provisional Patent Application No. 61/259,852, filed Nov. 10, 2009, entitled “RADOME SANDWICH PANEL STRUCTURAL JOINT,” naming inventors David Stresing and Kevin Todd, which application is incorporated by reference herein in its entirety.

### FIELD OF THE DISCLOSURE

The present disclosure generally relates to radomes, and more particularly relates to a radome sandwich panel structural joint.

### BACKGROUND

Generally, large radar antennas are covered with radomes to protect them from weather conditions and enable continuous precision operation. Radomes can be in the form of thin wall radomes, solid wall radomes, and sandwich radomes. Thin wall radomes have thickness typically less than 1/16 inch and may be supported using increased air pressure or using a supporting frame. Solid wall radomes are typically made of a heavier solid laminate, and sandwich radomes include a low dielectric core material sandwiched between thin inner and outer laminate layers. The core material is typically a plastic foam or a honeycomb structure.

While thin wall radomes can be formed from a continuous sheet of material, large solid wall radomes and sandwich radomes are generally assembled from a number of panels. The joints between the panels create deviations and discontinuities in the RF transparency characteristics of the radome. The joints can cause increased scattering of the radar signal, degrading performance and limiting the radome's operational frequency bandwidth. As such, radomes with improved joint characteristics would be desirable.

### BRIEF DESCRIPTION OF THE DRAWINGS

The present disclosure may be better understood, and its numerous features and advantages made apparent to those skilled in the art by referencing the accompanying drawings.

FIG. 1 is a diagram illustrating a cross section of a radome panel according to an aspect of the disclosure.

FIG. 2 is a diagram illustrating a joint between adjacent radome panels according to an aspect of the disclosure.

FIG. 3 is a graph illustrating the transmission efficiency across a joint between adjacent radome panels according to an aspect of the disclosure.

The use of the same reference symbols in different drawings indicates similar or identical items.

### DETAILED DESCRIPTION

In an embodiment, a radome can include a plurality of radome panels having a sandwich construction. Adjacent radome panels can be joined at an edge by partially overlapping skin layers of the radome panels. For example, a first skin of the first panel can extend past an edge and can overlap with the sandwich structure of the second panel. Additionally, a second skin of the second panel can extend past an edge and can overlap with the sandwich structure of the first panel.

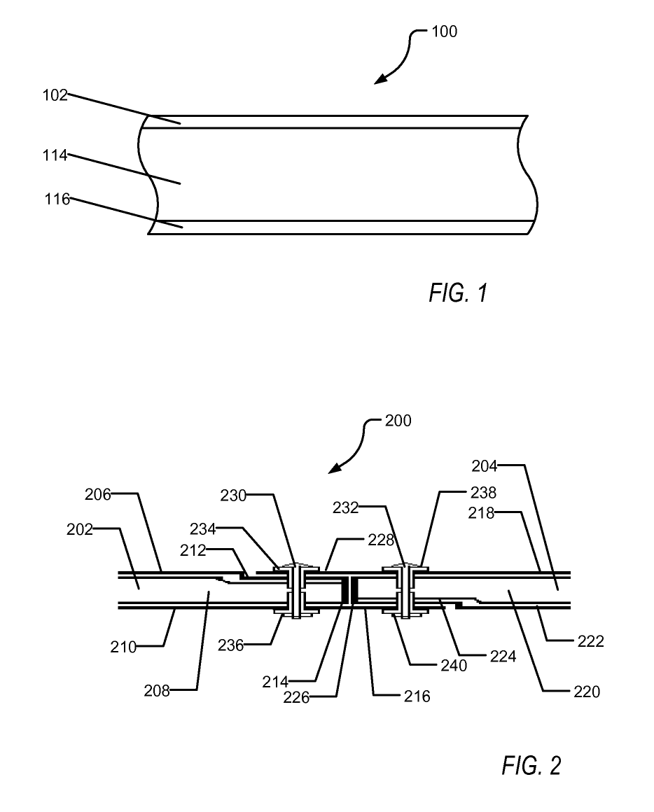

FIG. 1 illustrates a cross section of a radome panel 100. Radome panel 100 can be a sandwich radome, including a first skin 102, a second skin 104, and a core 106 between the first skin 102 and the second skin 104. The first skin 102 can include a fiber reinforced resin. The fiber reinforced resin can include a resin and a fibrous reinforcing material, such as glass fiber, aramid fiber, or the like. The fibrous reinforcing material can be a woven fabric or the fibers may be arranged randomly. The resin can include a thermosetting resin, such as polyester, epoxy, vinyl ester, or any combination thereof. Similarly, the second skin 104 can include a fiber reinforced resin. In an embodiment, the second skin 104 and the first skin 102 can include the same resin and fibrous reinforcing material.

Additionally, a hydrophobic coating can be applied to the outer surface 108 of the first skin 102. The hydrophobic coating can be a fluoropolymer coating, a silicone coating, or any combination thereof. The hydrophobic coating improves the shedding of water, such as rain, to prevent the water from sheeting over the surface and reducing the effectiveness of the radar system.

The core 106 can be of plastic foam or honeycomb. For example, the foam can be a low density thermoplastic, including polyvinyl chloride (PVC), polyetherimide (PEI), styrene butadiene styrene (SBS), acrylonitrile butadiene styrene (ABS), or chemical combinations thereof. The honeycomb construction can be a fiber reinforced resin shaped to have hexagonally arranged ridges throughout.

In a particular example, the panel 100 may be flat. Alternatively, the panel 100 may be curved, having a concave major surface that generally faces inwardly when assembled into a radome. In general, a plurality of panels are assembled to form a radome, each of the panels forming a joint with at least one other panel.

FIG. 2 illustrates a cross section of a joint 200 between radome panels 202 and 204. Radome panel 202 can include first skin 206, core 208, and second skin 210. The skin and core thicknesses can be implemented to meet specific strength and transparency requirements. Additionally, radome panel 202 can include a thinned portion 212 adjacent to or contiguous with an edge 214 of radome panel 202, the thinned portion 212 having a thickness that is less than the average thickness of the panel 202. In an example, a thickness of the core 208 at the thinned portion 212 is less than the average thickness of the core 208 over the panel 202. In another example, the thickness of the first skin 206 is less than an average thickness of the first skin 206 over the panel 202 or a thickness at another location of the panel 202. Further, second skin 210 can include an extending portion 216 that can extend beyond edge 214. Additionally, the extending portion 216 may be thickened to increase the load bearing properties.

Similarly, radome panel 204 can include first skin 218, core 220, and second skin 222. Further, radome panel 204 can include a thinned portion 224 adjacent to or contiguous with the edge 226, and the first skin 218 can include an extending portion 228 that can extend beyond edge 226. Additionally, the extending portion 228 may be thickened to increase the load bearing properties.

When assembled, core 208 and core 220 may not overlap along a direction normal to the surface of the radome. Additionally, core 208 and core 220 can abut at edges 214 and 226, substantially touching or having a small distance therebetween. The distance can be not greater than about 10 mm, such as not greater than about 1 mm. Further, extending portion 216 of second skin 210 can overlap thinned portion 224. Similarly, extending portion 228 of first skin 218 can overlap thinned portion 212. The overlap between the extending portion 228 and the thinned portion 212 may be between about 1 cm and about 10 cm.

Radome panels 202 and 204 can be held together by fasteners 230 and 232. Fasteners 230 and 232 can be screws, pop rivets, bolts, dowel, or the like, or any combination thereof. Fastener 230 can extend through extending portion 228 of first skin 218, and thinned portion 212, including first skin 206, core 208, and second skin 210. Similarly, fastener 232 can extend through first skin 218, core 220, and second skin 222 at the thinned portion 224, and extending portion 216 of second skin 210. While the fasteners 230 and 232 are illustrated as being opposing on opposite sides of the joint at the same location along the edge of the panels 202 and 204, the fasteners 230 and 232 can be disposed in offset positions along the edge of the panels 202 and 204. Further, the number, relative positioning, size, and material of the fasteners used in the joint between panels 202 and 204 can be selected to provide a desired strength or performance.

Additionally, inserts 234, 236, 238, and 240 can be used to transfer load to skins 206, 210, 218, and 222. Inserts 234, 236, 238, and 240 can be plastic and may be bonded to skins 210 and 218. In a further example, one or more of the inserts 234, 236, 238, and 240 may include a flange portion connected perpendicular to a tube portion. The tube portion may be inserted into openings of the panels, the flange portion extending over the surface of the skin. Such inserts may provide addition strength to the panels at the joints or may translate bearing load to shear load in the skins. Alternatively, a washer may be used in place of an insert.

In an embodiment, the core material is substantially continuous across the joint, such that the gap between core 208 and 220 can be small. For example, the gap can be not greater than about 10 mm, such as not greater than about 1 mm. The core 208 and 220 can even be substantially contacting. Additionally, the overall thickness of the radome at the joint can be substantially similar to the overall thickness of the panels. Limiting the structural variations, including overall thickness, layer thickness, and spacing between the inner and first skin, can limit the differences in the RF properties at the joint as compared to at the center of the panel. By limiting the differences in the RF properties, the effect of the joints on the RF profile of the radome can be substantially reduced.

When the panels are curved as opposed to flat, a concave major surface of each panel 202 and 204 can face inwardly, such as toward the center of a radome. A convex major surface of each panel 202 and 204 can face outwardly and form an outer surface of a radome.

The panels 202 and 204 joined as illustrated, exhibit consistent transmission efficiency even across the joint. The transmission efficiency of the radome can be measured as a transmission, such as RADAR, sweeps across the joint between two panels. The joint variation can be defined as the difference between the maximum and minimum transmission efficiencies measured for a transmission swept from the center of a first panel, across the joint, and to the center of a second panel, divided by the average transmission efficiency, JV=(MaxTE−MinTE)/AvgTE. The joint variation of the radome can be not greater than about 10%, such as not greater than about 8%, or even not greater than about 5%.

In a particular example, a plurality of panels can be joined to form a structure. Each panel can include one or more edges including a skin extending past the edge and including a thinned region. For example, a skin that forms a first major surface extends beyond a first edge and a skin that forms a second major surface extends beyond a second edge. In an example, the second edge is on an opposite side of the panel as the first edge. Panels having complementary structures can be connected in series to form a structure. In particular, each panel may have curvature and may connected to other panels on each edge to form a three dimensional structure, such as a radome.

Turning to the method of forming the radome panels, in an embodiment, a first skin can be formed by placing multiple layers of woven fabric pre-impregnated with an uncured polymer resin into a first portion of mold. Alternatively, the fibers can be sprayed into the mold, resulting in randomly oriented fibers. Similarly, the second skin may be layered into a second portion of the mold. The core material can be placed into the first portion of the mold overlying the first skin, and the second portion of the mold can be place on top of the first portion of the mold, and the polymer resin can be allowed to cure, laminating the sandwich structure together. In an embodiment, the radome panel may be formed with all the layers meeting at an edge, and the core and non-extending skin can be cut back to leaving the extending portion.

Alternatively, the extending portion of the skin can be created as the sandwich panel is formed. For example, the second portion of the mold can extend further in a direction than the first portion, such that the fiber reinforced resin of the second skin extends beyond the edge of the core and the fiber reinforced resin of the first skin. In an embodiment, the mold portions can be offset so that at one edge, the first skin is extending, and at an opposite edge, the second skin is extending. The mold portions can be placed together to center the core material within the mold, allowing for each skin to extend in the appropriate direction.

In an embodiment, the mold portion may include a thickness offset in the mold portion to create the thinned region. Fewer layers, even no layers, of fibers can be layered over the thickness offset as compared to other regions of the panel, or the core material may be thinned in that region to accommodate the full thickness of the skin. Alternatively the thinned region can be formed by grinding down the fiber reinforced resin.

Embodiments of the panels, joined panels, and radomes described above exhibit desirable technical advantages. In particular, embodiments exhibit high transmission efficiency and low variance in transmission loss over the surface of the radome. In addition, embodiments provide a strong joint between panels without introducing transmission loss.

### EXAMPLES

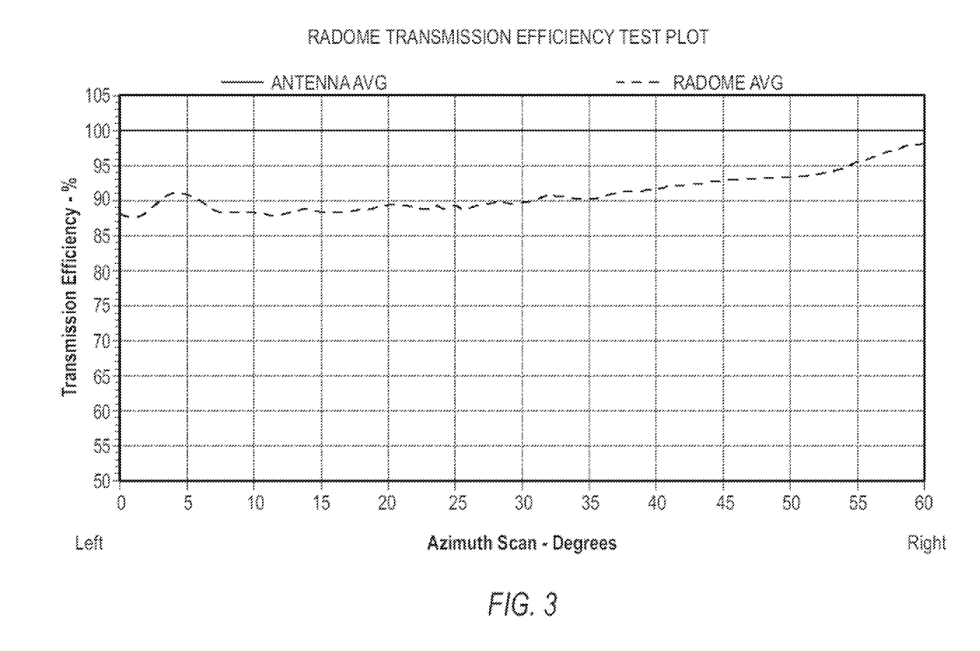

A radome section is prepared by joining two sandwich panels. The panels are joined with the defined hardware of FIG. 2 with a sealant, such as silicone or polysulfide to resist moisture ingression. The radome section is positioned in front of an X-band microwave frequency antenna so that the antenna is facing the center of the first sandwich panel. The antenna is scanned across the radome section such that the antenna scans across the joint and across the second panel. The transmission efficiency of the radome section is shown in FIG. 3. The increase between 0° and 5° is reflective noise typically seen in panel tests. The increase past 50° is due to the antenna turning to face open space passed the edge of the second sandwich panel. As can be seen, the radome section exhibits minimal variation in transmission efficiency as the antenna scans across the joint between the radome panels. The transmission efficiency through the joint region ranges from about 88% to about 92%, averaging about 90%. Accordingly, the joint variation of the radome is not greater than about 4.4% and is indicative of substantially no effect of the joint on the RF transparency.

In a first embodiment, a radome includes first and second panels disposed adjacent to each other and a fastener. Each panel of the first and second panels includes a core material disposed between first and second skin layers. The first and second skin layers define respective first and second major surfaces. A thickness of the each panel is defined between the first and second major surfaces. The core terminates at an edge of the each panel. The core of the first panel abuts the core of the second panel at respective edges. The first major surfaces of the first and second panels define a surface of the radome. A first skin layer of the first panel extends past the edge of the first panel and overlaps a thinned portion of the second panel defined contiguous with the edge of the second panel. The thinned portion of the second panel has a thickness less than an average thickness of the second panel. A first opening defined through the first skin layer of the first panel is in alignment with a second opening defined through the thinned portion of the second panel. The fastener extends through the first and second openings to secure the first panel to the second panel.

In an example of the first embodiment, the radome further includes an insert to extend into at least one of the first or second openings. The insert defines a lumen. The fastener extends through the lumen. In particular, the insert can include a flange portion and a tube portion extending perpendicular to the flange portion. The flange portion extends over one of the first or second major surfaces of the first or second panels. The tube portion extends into the at least one of the first or second openings.

In another example of the first embodiment, the second skin of the second panel extends beyond the edge of the second panel. The second skin of the second panel overlaps a thinned portion of the first panel. The thinned portion of the first panel is contiguous with the edge of the first panel. A third opening defined through the second skin of the second panel aligns with a fourth opening defined through the thinned portion of the first panel. A second fastener extends through the third and fourth openings.

In a further example, the first and second skin layers of the each panel comprise a fabric reinforced resin. In an additional example, in proximity to the joint between the first and second panels, the radome exhibits a Joint Variation of not greater than 10%, such as not greater than 8%, or even not greater than 5%.

In an additional example, along the extent of the thinned portion of the second panel, the first skin layer of the second panel is thinner than an average thickness of the first skin layer. In another example, along the extent of the thinned portion of the second panel, the core of the second panel is thinner than an average thickness of the core.

In a second embodiment, a method of forming a radome includes aligning edges of first and second panels. Each panel of the first and second panels includes a core material disposed between first and second skin layers. The first and second skin layers define respective first and second major surfaces. A thickness of the each panel is defined between the first and second major surfaces. The core terminates at an edge of the each panel. The core of the first panel abuts the core of the second panel at respective edges. A first skin layer of the first panel extends past the edge of the first panel and overlaps a thinned portion of the second panel defined contiguous with the edge of the second panel. A thickness of the thinned portion is less than the average thickness of the second panel. A first opening defined through the first skin layer of the first panel aligns with a second opening defined through the thinned portion of the second panel. The method further includes extending a fastener through the first and second openings to secure the first panel to the second panel. In an example of the second embodiment, the method further includes inserting an insert into at least one of the first or second openings, the insert defining a lumen, the fastener extending through the lumen.

In another example of the second embodiment, the insert includes a flange portion and a tube portion extending perpendicular to the flange portion. Inserting the insert includes inserting the tube portion into the at least one of the first or second openings. The flange portion extends over one of the first or second major surfaces of the first or second panels.

In a further example of the second embodiment, the second skin of the second panel extends beyond the edge of the second panel. The second skin of the second panel overlaps a thinned portion of the first panel. The thinned portion of the first panel is contiguous with the edge of the first panel. A third opening defined through the second skin of the second panel aligning with a fourth opening defined through the thinned portion of the first panel. A second fastener extends through the third and fourth openings.

In an additional example of the second embodiment, in proximity to the joint between the first and second panels, the radome exhibits a Joint Variation of not greater than 10%, such as not greater than 8%, or even not greater than 5%.

In a further example of the second embodiment, along the extent of the thinned portion of the second panel, the first skin layer of the second panel is thinner than an average thickness of the first skin layer. In another example, along the extent of the thinned portion of the second panel, the core of the second panel is thinner than an average thickness of the core.

In a third embodiment, a radome panel includes a body including a core material and a first skin on a major surface of the core material. The body has an edge. The first skin extends past the edge. In an example of the third embodiment, the first skin includes a fabric reinforced resin. In additional example of the third embodiment, the core material includes a foam, a honeycomb material, or any combination thereof.

In a further example of the third embodiment, the body further includes a second skin on an opposite surface of the core material such that the core material is sandwiched between the first and second skins. In an additional example, the second skin includes a thinned portion adjacent to the edge. The thinned portion has a thickness less than the thickness of another portion of the second skin. In another example, the second skin includes a fabric reinforced resin. In a further example, the first skin and the second skin include substantially the same material.

In a fourth embodiment, a radome panel includes a body comprising a first skin, a second skin, and a core material between the first and second skins. The core has an edge. The first skin has an overlap portion extending past the edge. The second skin ends at the edge and has a thinned portion adjacent to the edge.

In an example of the fourth embodiments, the first skin includes a fabric reinforced resin. The second skin includes a fabric reinforced resin. The first skin and the second skin can include substantially the same material. In another example, the core material includes a foam, a honeycomb material, or any combination thereof.

In an additional example of the fourth embodiment, the thinned portion of the second skin has a thickness less than the thickness of another portion of the second skin. In a further example, the overlap portion of the first skin has a thickness greater than the thickness of another portion of the first skin.

In a fifth embodiment, a radome includes first and second panels joined at respective first and second edges. The first and second panels each comprising a sandwich structure having a first skin, a second skin, and a core material between the first skin and the second skin. The first skin of the first panel extends past the first edge and overlap with the sandwich structure of the second panel. The second skin of the first panel ends at the first edge, and the second skin of the second panel extends past the second edge and overlaps the sandwich structure of the first panel. The first skin of the second panel ends at the second edge. The radome further includes a fastener extends through the first skin of the first panel and the sandwich structure of the second panel.

In an example of the fifth embodiment, the first panel has a thinned portion adjacent to the first edge. The thinned portion has a reduced thickness of the second skin. In another example, the second panel has a thinned portion adjacent to the second edge. The thinned portion has a reduced thickness of the first skin. In a further example, the core material of the first panel abuts and substantially aligns with the core material of the second panel.

In an additional example of the fifth embodiment, the first skin includes a fabric reinforced resin. The second skin can include a fabric reinforced resin. The second skin and the first skin can include substantially the same material. In an example, the core material includes a foam, a honeycomb material, or any combination thereof.

In another example of the fifth embodiment, a second fastener extends through the second skin of the second panel and the sandwich structure of the first panel.

In a sixth embodiment, a radome includes first and second panels joined at respective first and second edges. The first and second panels each includes a sandwich structure having a first skin, a second skin, and a core material between the first skin and the second skin. The first edge of the first panel includes a thinned portion having a thinned second skin. The second edge of the second panel includes a thinned portion having a thinned first skin. The first skin of the first panel extends beyond the edge of the first panel and overlaps with the thinned portion of the second panel. The second skin of the second panel extends beyond the edge of the second panel and overlaps the thinned portion of the first panel. The radome also includes a fastener extending through the first skin of the first panel and the thinned portion of the second panel.

In an example of the sixth embodiment, the core material of the first panel abuts and substantially aligns with the core material of the second panel. In a further example, the first skin includes a fabric reinforced resin. The second skin can include a fabric reinforced resin. The second skin and the first skin can include substantially the same material. In an example, the core material includes a foam, a honeycomb material, or any combination thereof. In a further example of the sixth embodiment, the radome further includes a second fastener extending through the second skin of the second panel and the thinned portion of the first panel.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A radome comprising:
first and second panels disposed adjacent to each other, each panel of the first and second panels comprises a core material disposed between first and second skin layers, the first and second skin layers defining respective first and second major surfaces, a thickness of the each panel defined between the first and second major surfaces, the core terminating at an edge of the each panel, the core of the first panel to abut the core of the second panel at respective edges, a first skin layer of the first panel to extend past the edge of the first panel and to overlap a thinned portion of the second panel defined contiguous with the edge of the second panel, the thinned portion of the second panel having a thickness less than an average thickness of the second panel, a first opening defined through the first skin layer of the first panel being in alignment with a second opening defined through the thinned portion of the second panel; and
a fastener to extend through the first and second openings to secure the first panel to the second panel.

2. The radome of claim 1, further comprising an insert to extend into at least one of the first or second openings, the insert defining a lumen, the fastener extending through the lumen.

3. The radome of claim 2, wherein the insert includes a flange portion and a tube portion extending perpendicular to the flange portion, the flange portion to extend over one of the first or second major surfaces of the first or second panels, the tube portion to extend into the at least one of the first or second openings.

4. The radome of claim 1, wherein the second skin of the second panel extends beyond the edge of the second panel, the second skin of the second panel to overlap a thinned portion of the first panel, the thinned portion of the first panel contiguous with the edge of the first panel, a third opening defined through the second skin of the second panel to align with a fourth opening defined through the thinned portion of the first panel, a second fastener to extend through the third and fourth openings.

5. The radome of claim 1, wherein the first and second skin layers of the each panel comprise a fabric reinforced resin.

6. The radome of claim 1, wherein, in proximity to the joint between the first and second panels, the radome exhibits a Joint Variation of not greater than about 10%.

7. The radome of claim 6, wherein the Joint Variation is not greater than about 8%.

8. The radome of claim 7, wherein the Joint Variation is not greater than about 5%.

9. The radome of claim 1, wherein, along the extent of the thinned portion of the second panel, the first skin layer of the second panel is thinner than an average thickness of the first skin layer.

10. The radome of claim 1, wherein, along the extent of the thinned portion of the second panel, the core of the second panel is thinner than an average thickness of the core.

11. A method of forming a radome, the method comprising:
aligning edges of first and second panels, each panel of the first and second panels comprising a core material disposed between first and second skin layers, the first and second skin layers defining respective first and second major surfaces, a thickness of the each panel defined between the first and second major surfaces, the core terminating at an edge of the each panel, the core of the first panel to abut the core of the second panel at respective edges, a first skin layer of the first panel extending past the edge of the first panel and overlapping a thinned portion of the second panel defined contiguous with the edge of the second panel, a thickness of the thinned portion being less than the average thickness of the second panel, a first opening defined through the first skin layer of the first panel aligning with a second opening defined through the thinned portion of the second panel; and
extending a fastener through the first and second openings to secure the first panel to the second panel.

12. The method of claim 11, further comprising inserting an insert into at least one of the first or second openings, the insert defining a lumen, the fastener extending through the lumen.

13. The method of claim 12, wherein the insert includes a flange portion and a tube portion extending perpendicular to the flange portion, wherein inserting the insert includes inserting the tube portion into the at least one of the first or second openings, the flange portion extending over one of the first or second major surfaces of the first or second panels.

14. The method of claim 11, wherein the second skin of the second panel extends beyond the edge of the second panel, the second skin of the second panel overlapping a thinned portion of the first panel, the thinned portion of the first panel being contiguous with the edge of the first panel, a third opening defined through the second skin of the second panel aligning with a fourth opening defined through the thinned portion of the first panel, a second fastener extending through the third and fourth openings.

15-19. (canceled)

20. A radome panel comprising:
a body comprising a core material and a first skin on a major surface of the core material, the body having an edge,
the first skin extending past the edge.

21. The radome panel of claim 20, wherein the first skin includes a fabric reinforced resin.

22. The radome panel of claim 20, wherein the core material includes a foam, a honeycomb material, or any combination thereof.

23. The radome panel of claim 20, wherein the body further includes a second skin on an opposite surface of the core material such that the core material is sandwiched between the first and second skins.

24. The radome panel of claim 23, wherein the second skin includes a thinned portion adjacent to the edge, the thinned portion having a thickness less than the thickness of another portion of the second skin.

25. The radome panel of claim 23, wherein the second skin includes a fabric reinforced resin.

26-32. (canceled)

33. The radome panel of claim 20, wherein the first skin includes a thickened portion extending past the edge and the thickened portion has a thickness greater than the thickness of another portion of the first skin.

34. A radome comprising:
first and second panels joined at respective first and second edges, the first and second panels each comprising a sandwich structure having a first skin, a second skin, and a core material between the first skin and the second skin, the first skin of the first panel extending past the first edge and overlapping with the sandwich structure of the second panel, the second skin of the first panel ending at the first edge, and the second skin of the second panel extending past the second edge and overlapping the sandwich structure of the first panel, the first skin of the second panel ending at the second edge; and
a fastener extending through the first skin of the first panel and the sandwich structure of the second panel.

35. The radome of claim 34, wherein the first panel has a thinned portion adjacent to the first edge, the thinned portion having a reduced thickness of the second skin.

36. The radome of claim 34, wherein the second panel has a thinned portion adjacent to the second edge, the thinned portion having a reduced thickness of the first skin.

37-42. (canceled)

43. The radome of claim 34, wherein
the first edge of the first panel includes a thinned portion having a thinned second skin, and the second edge of the second panel includes a thinned portion having a thinned first skin.

44. The radome of claim 43, wherein the core material of the first panel abuts and substantially aligns with the core material of the second panel.

45. The radome of claim 43, wherein at least one of the first skin and the second skin includes a fabric reinforced resin.

46. (canceled)

47. (canceled)

48. The radome of claim 43, wherein the core material includes a foam, a honeycomb material, or any combination thereof.

49. The radome of claim 43, further comprising a second fastener extending through the second skin of the second panel and the thinned portion of the first panel.
